(19) United States
(12) Patent Application Publication
(10) Pub. No.: US 2020/0148254 A1
(43) Pub. Date: May 14, 2020

(54) RIDE VEHICLE AND TRACK SYSTEM

(71) Applicant: Earl Knight MAGRATH, III, Chattanooga, TN (US)

(72) Inventor: Earl Knight MAGRATH, III, Chattanooga, TN (US)

(21) Appl. No.: 16/191,155

(22) Filed: Nov. 14, 2018

(51) Int. Cl. B62D 6/00; G06K 7/10; B62D 15/02

(52) U.S. Cl. CPC B62D 6/001; B62D 15/029; G06K 7/10316

(57) ABSTRACT

A vehicle includes an antenna configured to receive a signal from a radio-frequency identification (RFID) tag and an on-vehicle operating system configured to identify a vehicle action based on the signal and to control the vehicle to perform the vehicle action. Additionally, the vehicle can include a user-operated steering mechanism, a user interface configured to receive user input to activate the vehicle action and instruct the on-vehicle operating system to control the vehicle and an on-vehicle message system configured to provide messages to a user of the vehicle. A system includes one or more vehicles that are operable on a track having a plurality of RFID tags disposed at various positions along the track.

### BACKGROUND OF THE INVENTION

### Field of the Invention

The present invention relates to amusement rides and more particularly to an enhanced, user-operated go-kart-type amusement ride.

### Description of the Background Art

Go-kart racing is a common amusement park ride. Typically, go-kart racing rides provide a basic track with a plurality of user-operated go karts where the drivers race their opponents around a track. Typically, the go-kart drivers drive around a short track for a few laps.

A problem with such go-kart races is that the amusement value of the race is limited to merely driving a go-kart around the track. There is little or no interaction between the racers and their opponents. Another problem is that generally, the go-karts are entirely user controlled. Since the go-karts are entirely user controlled it is difficult to monitor the driving behavior of the users, which can create an unsafe environment for the drivers and can result in damage to the go-karts.

Accordingly, there is currently a need for a go-kart racing system, which enhances the enjoyment of the user while also increasing the safety of the user.

### SUMMARY OF THE INVENTION

In view of the foregoing and other exemplary problems, drawbacks, and disadvantages of the conventional methods and structures, an exemplary feature of the present invention is to provide a go-kart-type vehicle with the ability to receive signals containing additional vehicle action capabilities to provide an increased level of entertainment for the operator of the vehicle.

According to a first non-limiting, exemplary aspect of the invention, a vehicle includes an antenna configured to receive a signal from radio-frequency identification (RFID) tag and an in-vehicle operating system configured to identify a vehicle action based on the signal and to control the vehicle to perform the vehicle action.

Additionally, the vehicle may include a user-operated steering mechanism, a user interface configured to receive user input to activate the vehicle action and instruct the on-vehicle operating system to control the vehicle and an on-vehicle message system configured to provide messages to a user of the vehicle.

According to a second non-limiting, exemplary aspect of the invention, a race track includes a track surface configured to allow a vehicle to drive along the track surface and a plurality of radio-frequency identification (RFID) tags embedded within the track surface, each of the plurality of RFID tags having a digital code that contains an actuatable vehicle action. When the vehicle drives over one of the plurality of RFID tags, the vehicle obtains the actuatable vehicle action.

According to a third non-limiting, exemplary aspect of the invention, a system includes a plurality of radio-frequency identification (RFID) tags disposed at various positions along a driveable track and a vehicle. The vehicle includes an antenna configured to receive a signal from the plurality of RFID tags as the vehicle is driven along the driveable track and an in-vehicle operating system configured to identify a vehicle action based on the signal and to control the vehicle to perform the vehicle action.

The vehicle and system according to the above exemplary aspects of the invention provide increased enjoyment by providing enhanced vehicle actions during a go-kart-type race. Additionally, the vehicle and system according to present invention provide increased safety by allowing for the system to automatically control certain actions of the vehicle. The system of the present invention allows the karts/vehicles to speed up and slow down based on a variety of controls both by the driver of the kart/vehicle, by the track attendant and by the automated control system that times and controls the race.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus, do not limit the present invention, and wherein:

FIG. 1 illustrates a system 100 according to an exemplary, non-limiting embodiment of the invention;

FIG. 2 illustrates a schematic illustration of a vehicle 200 according to an exemplary, non-limiting embodiment of the present invention; and

FIG. 3 illustrates a system 300 according to another exemplary, non-limiting embodiment of the invention.

### DETAILED DESCRIPTION

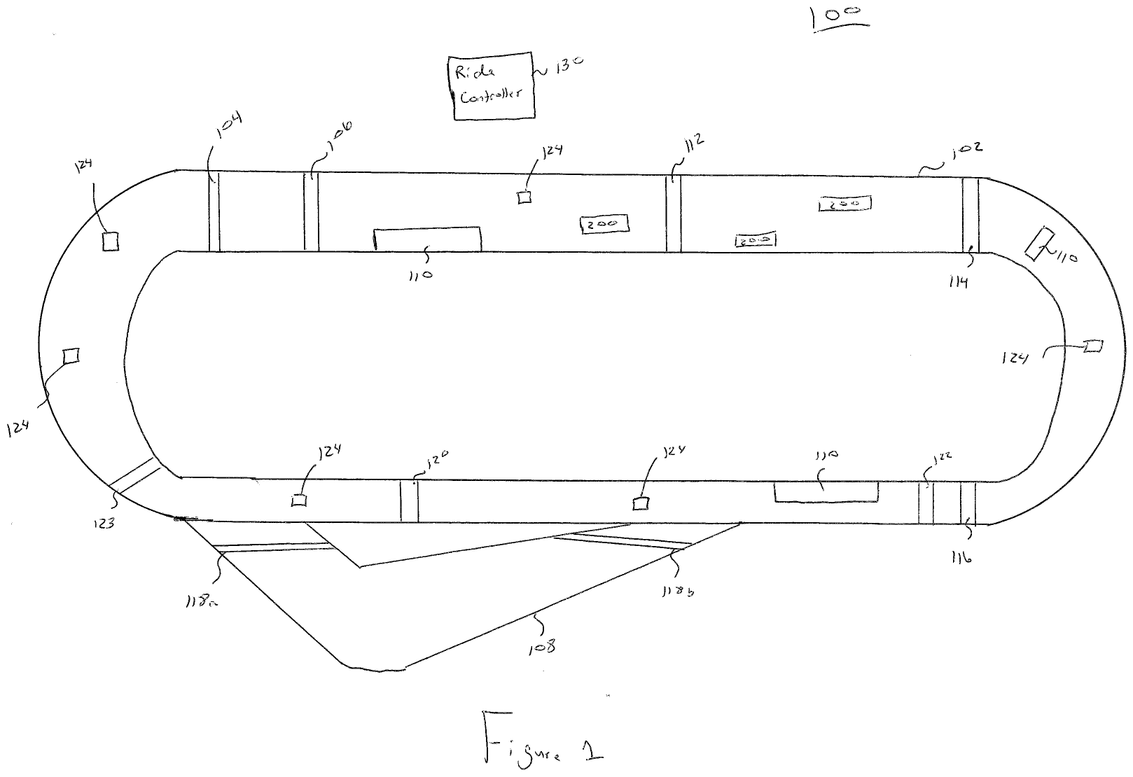

Referring now to the drawings, and more particularly to FIGS. 1-3, there are shown exemplary embodiments of the present invention.

FIG. 1 illustrates a system 100 according to an exemplary, non-limiting embodiment of the present invention. In accordance with certain exemplary embodiments of the present invention, the system is directed to an amusement park go-kart racing game. Specifically, the present system provides an enhanced go-kart racing game configured to provide enhanced and varied go-kart races. In accordance with certain embodiments of the invention, the system 100 includes one or more vehicles 200 that are configured to be controlled by a user (or rider) to drive along a track 102. In accordance with certain exemplary embodiments of the invention, the vehicles are amusement, go-kart-type vehicles.

The system 100 further includes a plurality of zones arranged at various locations along the track. Each of the plurality of zones is identified by a zone strip. The zone strips mark either a start or finish of a specific zone. For example, the exemplary system 100 illustrated in FIG. 1 includes a start/finish speed zone strip 106, which identifies the starting point and finishing point for a race on the track. The system 100 also includes a deceleration zone start strip 116 and a deceleration zone end strip 114, which identify an area of the track in which the vehicles 200 will operate at a reduced speed. The system 100 also includes a plurality of colored zones (e.g., gold zone strip 112, blue zone strip 120, orange zone strip 122, yellow zone strip 123), each of which provide different features to the vehicles 200 and which will be described in further detail below.

The track 102 also includes a pit 108. In accordance with the pit 108, the track 102 has a pit approach zone strip 104, which indicates that a kart is approaching the pit 108, a pit entry strip 118a, which indicates that the kart has entered the pit 108, and a pit exit strip 118b, which indicates that the kart is exiting the pit 108.

Furthermore, the track 102 has one or more obstacles 110 positioned around the track at various locations. For example, the obstacles 110 can include mud pits, rumble strips, water hazards or speed bumps. It is noted that this is merely a non-exhaustive, exemplary listing of possible obstacles and the system 100 is not limited to only the above-listed on-track obstacles.

Additionally, one or more power-ups 124 are positioned at various locations along the track. When a kart 200 drives over a position of a power-up, the kart 200 obtains a specific power or ability that can either enhance the operation of that kart or limit the operation of another kart on the track 102. In some instances, the kart will immediately and automatically receive the benefit of the power up. In other instances, the kart will obtain the power-up, but the benefit of the power-up will not be activated until initiated by the operator of the kart. If a driver of the kart 200 elects to hold onto a power, instead of immediately using the power, the power-up can become stronger as laps pass. For example, if a power-up is initially set to last for ten seconds, if the driver holds the power-up for two laps, for example, the power-up, when used, will then last longer (e.g., 20 seconds).

The obstacles 110, the power ups 124 and the zone strips (104, 106, 112, etc.) all include a sending unit. Specifically, at each specific location of an obstacle 100, a power-up 124 and the zone strips (104, 106, 112, etc.), a radio-frequency identification (RFID) tag is embedded in the track. The RFID tags transmit a signal identifying the specific location of the kart and identifying one or more of a variety of features depending on the state of the race and the action programmed for that specific point on the track 102.

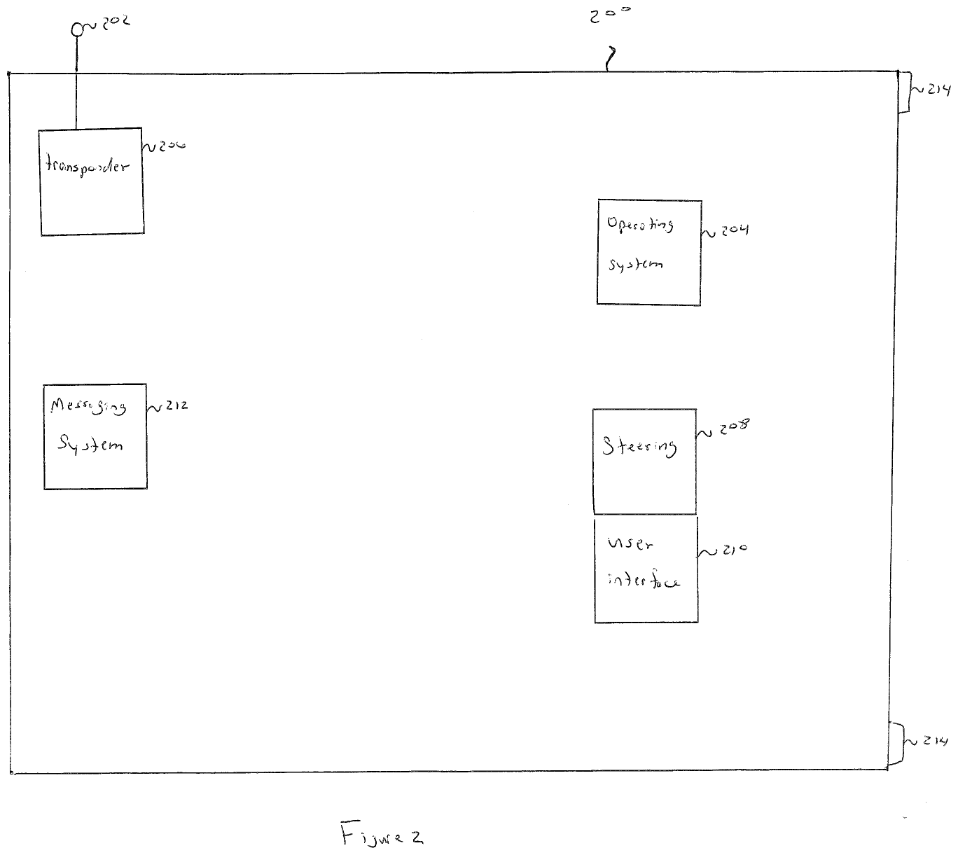

Referring to FIG. 2, each kart/vehicle 200 includes an antenna 202 that receives a signal from the RFID tags to sense when the kart/vehicle 200 crosses a tag by obtaining the digital code of the RFID tag. Each kart/vehicle 200 includes a transponder 206 configured to communicate with a ride controller 130. The ride controller 130 is a component of the system, separate from the vehicles 200, that is configured to control aspects of the system, including the track 102, power-ups 124, and vehicles 200, etc. Additionally, the ride controller 130 starts, runs, times and ends the race. Once the antenna 102 receives the digital code from one of the RFID tags on the track, the transponder 206 transmits the digital code to the ride controller 130 by a radio-frequency (RF) signal. Once the ride controller 130 receives the digital code of the RFID tag, the ride controller 130 uses the digital code to identify a required action and transmits a corresponding command signal back to the transponder 206 of the kart/vehicle 200 to perform the desired action. For example, the ride controller 130 can active a pre-programmed action on a specific kart, turn off or on features on one or more of the karts, or remove features of one or more karts temporarily and later send a resume command after a preset time has expired. The ride controller 130 can automatically cause or cease an action on the one or more vehicles or provide a user of the one or more karts the ability to activate or deactivate a function of the kart at the user's desire.

FIG. 2 is a schematic drawing illustrating a kart 200 according to certain exemplary embodiments of the present invention. In addition to the antenna 202 and the transponder 206 detailed above, each kart 200 also includes an on-vehicle operating system 204. The on-vehicle operating system 204 is configured to identify a vehicle action based on the digital code received from the RFID tag and to control the vehicle to perform the vehicle action. More specifically, in some instances, based on the digital code from the RFID tag, the on-vehicle operating system 204 will automatically control the vehicle to perform a certain function (e.g., increase or decrease speed of the vehicle). In other instances, based on the digital code from the RFID tag, the on-vehicle operating system 204 will not activate the vehicle action (power-up) until the user/driver of the kart 200 actuates a control operation to initiate the vehicle action.

Each vehicle/kart 200 includes a user interface 210 configured to allow an operator (i.e., user/driver) of the kart 200 to selectively initiate the vehicle action (power up). In certain exemplary embodiments, the user interface 210 is disposed on a steering mechanism 208 of the vehicle/kart 200. More specifically, the user interface 210 includes one or more user actuatable buttons disposed on a steering wheel of the vehicle/kart 200. Once the on-vehicle operating system 204 receives the digital code of the RFID tag from the ride controller 130 and makes the power-up available, the operator of the vehicle 200 is able to selectively activate a vehicle action by actuating the one or more buttons on the user interface 210. For example, the user interface 210 can include a power-up button. Each time a power-up is obtained, the driver of the kart 200 can choose when to activate the power-up by pressing the power-up button on the user interface 210. Additionally, the user interface 210 can include a separate button that merely indicates the type of power-up obtained, but does not activate the power-up. Finally, the user interface 210 can also include a reverse button that allows a driver to reverse his/her kart if spun out or in an accident.

Furthermore, each vehicle/kart 200 includes a messaging system 212. In accordance with certain exemplary embodiments of the invention, the messaging system 212 includes a built-in audio system in each kart 200 to audibly convey messages, engine noises, game directions and a variety of race and game related messages. For example, the messaging system 212 on the kart 200 is configured to play sound files informing the racer of power-ups collected, when the power-ups have been activated, how long the power-ups last, what the power-ups are, when a user's kart has been affected by other racers using power-ups against them, when a power on the track slows them down (e.g., driving over the wrong spot), when the race starts, is delayed, stops, restarts, is over, safety messages, background noises, crowd cheering noises, tips from a crew chief on how to drive better or use power-ups and track announcer messages. Indeed, each RFID tag in the power-up spots, the zone-strips and the obstacles, has at least one corresponding message playable by the messaging system 212. For example, when a race is completed, the messaging system 212 will play, based on a command from the ride controller 130, an end-of-race message in each kart to inform the drivers that the race is over. The ride controller 130 will then slow the karts 200 before they enter the pit 108. By using audio messaging instead of visual displays, the system 100 of the present invention makes the kart safer for the driver. However, the messaging system 212 can also be configured to include a visual display in addition to or in place of the audio messages. For example, a visual display could be used to display the power-ups currently held or in use, or a score display showing the winners (i.e., order or races first to last). The messages played by the messaging system are played based on commands from the ride controller 130 and/or based on the digital code in the RFID tags.

Finally, the kart 200 includes one or more lights 214 (e.g., LED lights) for providing operational information, for safety and for decoration. In the exemplary embodiment of the vehicle/kart 200 illustrated in FIG. 2, the lights 214 are positioned on an exterior of the vehicle/kart 200. Additional lights may be included on an interior of the vehicle/kart 200 to provide information to the driver. For example, the kart 200 may include taillights that flash when a kart is attacked by a power-up or in a state of reduced speed. Also, the kart 200 may have various colored lights on the user interface 210 to indicate the type of power-up obtained. For example, a red light can indicate that an offensive power-up has been obtained and a blue light can indicate that a defensive power-up.

As detailed above, the user interface 210 is configured to allow an operator of the vehicle to activate a power up. Additionally, the operator of the vehicle can also use the user interface 210 to play an informational message through the messaging system 212, reverse the kart 200, check their position or place in a current race, or activate shields and/or other game features.

As detailed above, each kart/vehicle 200 has a user interface 210 that the driver may use to activate power-ups gained by crossing RFID tags embedded in the track. During a race, the RFID tags are identified by targets in the track. For example, the RFID tag may be identified by targets that light up and/or change colors, painted areas small and large, zone strips, and entire sections of the track that are lighted or painted a certain color to identify the presence of a power-up. These areas may be lighted or colored during the entire race or only at certain times during the race. Additionally, the messaging system 212 in each kart 200 can indicate to the driver when certain features or power-ups are available to be obtained.

When a racer obtains a power-up, the racer must decide when to use it to get the best gain over his/her opponents. In accordance with certain aspects of the invention, the race rules may limit the racer to only be able to have one power-up at a time. Once used, the racer can then gain a new power-up by crossing another RFID tag. Each time the racer gains a power-up, a message is played in the kart 200 through the messaging system 212 informing the racer of the power-up. The driver can, using the user interface 210, replay the message. The messaging system 212 will play a first message when the racer receives the power-up or is affected by another racer's power-up. The messaging system 212 will play a second message when the power-up no longer affects the kart 200.

The driver can activate a power-up using the user interface 210 in the kart 200. For example, the user can press a button (user interface 210) on the steering mechanism 208 to active the obtained power-up. Depending on the power-up, the message system 212 in the driver's vehicle 200 will play a message indicating that the power-up is activated. Additionally, if the power-up is one that effects other racers, then the messaging system in the other racer's kart will play a message indicating that the power-up is in use.

The messaging system 212 is able to provide several types of messages throughout a race. For example, the messaging system 212 can play a message in all karts 200 at the start of a race such as: “Welcome racers to POWER-UP KARTING. Your race is about to start, so fasten your seatbelt tightly and secure all loose clothing and long hair. To operate your kart, the accelerator is your right foot and the brake is your left foot. Use the steering wheel to avoid hitting other karts, barriers or obstacles. Any racer bumping, swerving, or hitting the rail will be penalized and may result in removal from the track without a refund. If a problem occurs with your kart during the race, stay seated and raise your right hand.” This is merely an exemplary message that may be played at the start of the race and/or any time the racers enter and exit the pit area. Similarly, the messaging system 212 will play an informative message as the race starts and the karts 200 enter the track 102 from the pit 108. This message will include information regarding the race and explaining power-ups. When the race is over, the messaging system will play an end of race message such as: “Attention racers, the checkered flag is out and we have a winner. Please proceed to the pit at this time. Enter the pit slowly and watch for the attendant to direct you to your pit lane.” This can then be followed by an exit message, instructing the drivers to exit their karts.

The messaging system 212 can also provide safety messages from the ride controller 130 to the drivers throughout a race. For example, if an accident occurs between one or more karts occurs during the race, the messaging system 212 will play a message: “The red flag is out and the race has stopped temporarily. Stay in your kart. There is an accident on the track. Please stay seated until the race resumes and remove your foot from the accelerator.” Once the accident is cleared, the messaging system will play a message indicating that the race has resumed and the racers may proceed to drive their karts. Similarly, if a kart 200 spins out on the track or is otherwise stuck, the messaging system 212 can provide a specific message to the affected kart 200 with instructions. For example, the message would say: “If you have spun out, press the red reverse button on the steering wheel to back your kart up.”

The messaging system 212 can also play crew chief messages providing advice to a racer during the race. For example, if a user is excessively using the vehicle brake, the ride controller 130 will cause the messaging system to play a message such as: “If we're going to have any chance to win this race, don't press the gas and the brake at the same time.” Additionally, the messaging system 212 can play a message such as: “If you want to win the race, drive over the lighted targets and win some power-ups.” Similarly, if a kart 200 obtains a power-up, the messaging system 212 can play a message such as: “Use your power-up. Press the right button on the steering wheel and make passing your opponents easier.”

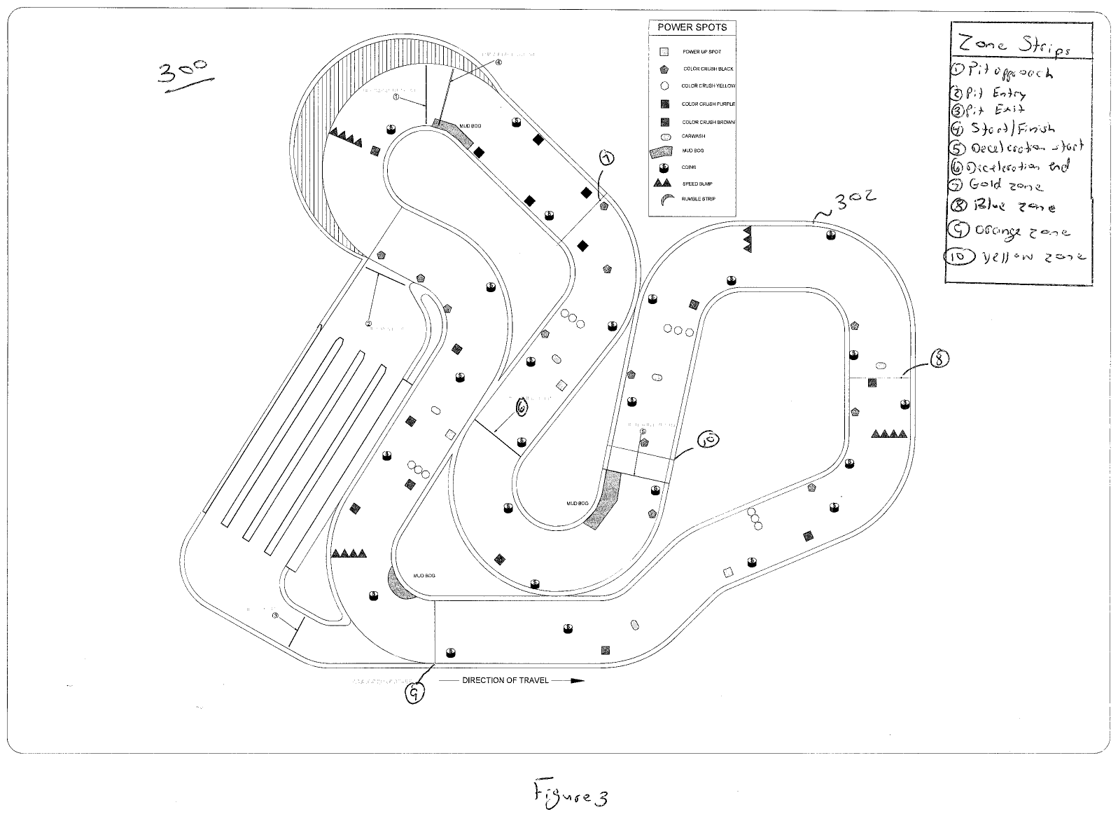

FIG. 3 illustrates a specific example of the system 300 used in accordance with one more race-type games that can be played using the system of the present invention. The specific power-ups and zone strips are identified in the track 302 by the legends in FIG. 3. The system 300 in FIG. 3 utilizes the same kart 200 detailed above and also the same ride controller 130. FIG. 3 illustrates a specific example of a configuration of the track 302.

The system 300 provides an interactive go kart racing game that allows racers to affect other racers' ability to win by obtaining powers that can be used to change their opponent's kart speed and/or function. The power ups can include boost, turtle mode, shield, red light/green light, zone flip and money move, for example. Boost allows a player to speed up their kart as much as 20% to allow the racer to pass his/her opponents more easily. The power-up last for only a set amount of time (e.g., 15 seconds) once the user activates the power-up and only the user's kart will speed up. Turtle mode is a power that slows all the karts on the track by 20%, except the racer who activated the power-up. The shield power-up is used to prevent either a red-light or a turtle power from slowing down the kart 200. Certain power-up spots are configured to alternate between a red light and a green light. To win a power-up at a red light/green light spot, the driver must drive the kart 200 over the lighted spot in the track when it is lit green. If the lighted spot is red, then the kart will not obtain the power-up and will be slowed down for a set period of time (e.g., 15 seconds). A zone flip power-up allows a racer holding the power-up to flip a power-up spot from green light to red light, or vice versa, before his opponent passes over the spot. A money move power-up allows a driver to stop all other karts except his own so that the driver may drive around all of his opponents.

The track 302, in addition to the power-ups, may also include a number of obstacles around the track. The obstacles can include, for example, mud pits, rumble strips, speed bumps, pot holes or car washes. While some of these obstacles could be provided as real world, physical obstacles (e.g., an actual pit of mud to slow down cars), in accordance with certain exemplary embodiments of the invention, and in an effort to maintain the integrity of the karts 200, the obstacles are also RFID tags embedded at various locations around the track. For example, a pot hole is a small painted spot on the track 302 that when crossed will slow down the speed of a kart 302 a set amount (e.g., 10%) for a set period of time (e.g., 5 seconds). Similarly, a mud pit is a larger (i.e., larger than the pot hole) painted spot (e.g., a brown painted spot) on the track 302 that when crossed by a kart 200 will slow down the kart 200 for a set time (e.g., 15 seconds). Similarly, a speed bump is a painted spot on the track that will slow down a kart 200 that passes over the speed bump.

Anytime a kart passes over one of the above obstacles, the messaging system 212 in the kart 200 will play a message related to the obstacle informing the driver of the kart 200 that they are affected by the obstacle. For example, if a kart 200 passes over a speed bump, the messaging system 212 will play a message such as: “Since you can't miss the speed bumps, we'll just slow down your kart for you.” Similarly, if a kart 200 passes over a pot hole, the messaging system 212 will play a message such as: “Pot hole attack: You zigged when you should have zagged. Got to avoid those red spots!”

Another feature/obstacle is a rumble strip. In the exemplary track illustrated in FIG. 3, the rumble strip is illustrated along one of the curves of the track. When a kart 200 passes into the rumble strip area, the ride controller 130 will cause a series of quick brakes on the kart 200 to slowdown the kart and avoid crashing into the side of the track 302. The messaging system of the kart will play a message such as: “That ought to wake you up! Keep it on the track and off the shoulder if you want to win the race.”

Yet another feature on the track 302 is a car wash spot. When a kart 200 passes over the car wash spot, any power-ups affecting the kart 200 will be wiped out. The messaging system 212 will play a message such as: “The car wash is scrubbing away those nasty powers.”

The track 302 can also include one or more colored hot zones (e.g., gold zone, blue zone, yellow zone, orange zone). When activated (e.g., by the ride controller 130 or a driver activating a hot zone power-up), the speed of all karts 200 within the zone are slowed down. Each of the hot zones, when activated, has its own message that is played through the messaging system 212 of affected karts 200. Each message will play for a set time (e.g., 10 seconds) for the duration of the reduced speed. For example, in the orange hot zone a laughing noise will play, in the blue hot zone a giggling noise will play, in the yellow zone a mule braying noise will play and in the gold zone a different laughing noise will play.

Additionally, the track 302 includes RFID tag spots designated as coin spots. A driver can collect coins to receive upgraded kart speed for a duration of time or an entirety of the race. For example, each coin obtained can increase the top speed of a kart obtaining the coin. Furthermore, if a driver obtains a set number of coins (e.g., 6 coins), the kart 200 will obtain maximum kart speed. Another feature of the system 300 is that a user can lose coins when affected by another user's power-up. When a kart 200 obtains a coin, the messaging system 212 will play an indication message such as: “Ding-ding-ding-ding.” The messaging system 212 will also notify the driver when he/she has acquired the total number of coins required for maximum speed or lost coins due to an action of an opponent.

Another feature is the power swap feature, which allows a driver to change a power at the start/finish line for a different power. Additionally, the system 300 can limit certain power-ups depending on a kart's position in the race. That is, depending on a racer's position in the race, certain power-ups will not be available. For example, if a racer is in first place, the turtle mode power-up, which reduces the speed of all other karts on the track 302, will not be available that racer.

A ranged attack is an offensive power-up gained by driving over a power-up spot at a specific time. This attack can be used to slow down all karts in a zone ahead of the driver or behind the driver depending on when the driver activates the power-up.

The track 302 can also include power steal zones. If a driver forces an opponent to drive through the power steal zone, the driver may gain a power-up held by the opponent.

Finally, the track 302 may include speed boost spots. The speed boost spots work opposite to the obstacles such as the mud pit. That is, if a kart 200 passes over a speed boost spot, then the kart 200 will receive an immediate speed boost.

Another option of a race is the ability to assign points based on the final score of the racer. For example, scoring options can include who has the fastest time, who collects the most points (e.g., by power-ups and/or coins), who had the highest total points (e.g., getting hit by power-ups or hitting bad spots on the track that can reduce the score) or determining the winner by a combination of fastest time, speed and points.

In accordance with the above exemplary configurations of the present invention, a system is provided in which functions can be automatically performed based on a location of the vehicle/kart 200 on the track 102/302. The system provides a large variety of features that can make the vehicle/kart safer, more interactive and more automated. For example, the system can activate sound files when a kart passes a certain point including safety messages (e.g., slow down around curve), operational messages (boost power-up is activated), entertainment messages (e.g., cheering sound effects, site specific sound files, engine sounds, wooden roller coaster sound as a kart climbs a hill, location dependent sounds (e.g., “we have a winner” when a kart passes the finish line first) or directional messages (e.g., “you are now entering the pit, slow down and watch for the attendant”).

The system 100/300 also provides the advantage of enhancing user enjoyment with power-ups and increasing user safety during a race. The system 100/300 is able to activate and deactivate certain enhanced features during a race. For example, the system provides the boost feature, which allows the kart to travel at an increased speed for a set time so a user can more easily pass opponents. To improve safety, the system can deactivate the boost feature before entering a tight turn and reactivate the boost feature after the kart leaves the tight turn. Additionally, the system can slow down a kart as it travels down a steep hill to allow a user to safely navigate a turn at the bottom of the hill, and then return the kart to its previous speed following the turn. Similarly, the system can increase the speed of a kart to allow the kart to easily climb a hill and then reduce the speed of the kart before the kart goes over the top of the hill.

Furthermore, the system 100/300 can activate sound messages and features simultaneously so that the racer(s) knows that an action was intentional and caused by the system. For example, the system can decrease the speed of a kart(s) while simultaneously initiating a message such as: “You have entered the deceleration zone.”

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A vehicle, comprising:
an antenna configured to receive a signal from an RFID tag; and
an on-vehicle operating system configured to identify a vehicle action based on the signal and to control the vehicle to perform the vehicle action.

2. The vehicle according to claim 1, further comprising a user operated steering mechanism.

3. The vehicle according to claim 1, further comprising a user interface configured to receive user input to activate the vehicle action and instruct the on-vehicle operating system to control the vehicle.

4. The vehicle according to claim 1, further comprising:
a user operated steering mechanism; and
a user interface, disposed on the user operated steering mechanism, configured to receive user input to activate the vehicle action and instruct the on-vehicle operating system to control the vehicle.

5. The vehicle according to claim 4, wherein the user interface comprises a user-actuatable button on the user operated steering mechanism.

6. The vehicle according to claim 1, further comprising an on-vehicle message system configured to provide messages to a user of the vehicle.

7. A race track, comprising:
a track surface configured to allow a vehicle to drive along the track surface; and
a plurality of radio-frequency identification (RFID) tags embedded within the track surface, each of the plurality of RFID tags having a digital code that contains an actuatable vehicle action,
wherein when the vehicle drives over one of the plurality of RFID tags, the vehicle obtains the actuatable vehicle action.

8. The race track according to claim 7, wherein the plurality of RFID tags are associated with a lightable area on the track to identify the location of the RFID tags.

9. The race track according to claim 7, wherein each of the plurality of RFID tags corresponds to a vehicle-power up, a track obstacle or a track zone strip.

10. A system, comprising:
a plurality of RFID tags disposed at various positions along a driveable track; and
a vehicle, said vehicle comprising:
an antenna configured to receive a signal from the plurality of RFID tags as the vehicle is driven along the driveable track; and
an on-vehicle operating system configured to identify a vehicle action based on the signal and to control the vehicle to perform the vehicle action.

11. The system according to claim 10, further comprising a ride controller separate from the vehicle.

12. The system according to claim 11, wherein the vehicle further comprises a transponder configured to communicate with the ride controller.
